(19) United States
(12) Patent Application Publication
(10) Pub. No.: US 2004/0160411 A1
(43) Pub. Date: Aug. 19, 2004

(54) Optical input device with various illuminations in detecting a movement thereof

(76) Inventor: Yao-Chi Yang, San Chong (TW)

Correspondence Address: Raymond Sun, Suite 155, 20 Corporate Park, Irvine, CA, 92606, US

(21) Appl. No.: 10/446,404

(22) Filed: May 28, 2003

(30) Foreign Application Priority Data
Feb. 14, 2003 (TW) 92202359

(51) Int. Cl. G09G 5/00

(52) U.S. Cl. 345/156

(57) ABSTRACT

An optical input device has a light source for emitting a light beam over a working surface that generates a reflected light beam. The input device further includes an optical sensing module that detects the reflected light beam from the working surface, and which stores a coefficient. The input device also has a control unit coupled to the optical sensing module for reading the coefficient and outputting a feedback signal based on the coefficient, and a current controller coupled to the control unit for receiving the feedback signal and, based thereon, modulating the light beam generated by the light source.

### BACKGROUND OF THE INVENTION

1. Field of the Invention

The present invention relates to an optical input device, and in particular, to an optical input device where the intensity of the illuminations from the light source are modified during the detection of movement on a working surface.

2. Description of the Prior Art

Optical input devices, such as optical mice, are becoming more and more popular recently, so that a trend is forming to replace the conventional mouse having a ball thereunder with these optical input devices. The ball of a conventional mouse rolls and moves on a working surface to detect a movement corresponding to a cursor on a display. However, the effectiveness of the conventional mouse in detecting the movement of the mouse will gradually deteriorate due to the adherence of dust or dirt on the surface of the ball as the ball rolls and moves over a period of time. Therefore, a user has to frequently remove the dust or dirt from the ball and its related mechanisms.

An optical mouse avoids the dust and dirt problem described above. FIG. 1 is a very general schematic of a conventional optical mouse 1, having a light source 10 that projects a light beam over a working surface. An optical sensing module 11 detects a reflected light (refraction) from the working surface to form a first image. If the user continues to move the optical mouse, a second image will be obtained. Therefore, the MCU (micro control unit) 12 of the optical mouse 1 will then compare the first and second images to find the differences between the first and second images so as to generate a corresponding cursor-moving signal to a computer. In a conventional optical mouse, the light source 10 is usually illuminated at a fixed intensity. However, the ability to effectively detect the movement of the optical mouse is dependent upon a number of factors, such as the colors, the roughness and the material of the working surface. These factors will affect the refraction of light from the working surface. Sometimes, a working surface might provide poor refraction, or might provide an over-refraction, all of which will result in poor images being detected for processing by the MCU 12. To address these problems, the MCU 12 in some optical input devices is equipped with an auto-adjustment function to provide preferred images to be compared.

Two known ways to upgrade the quality of the images are to modulate either a frame rate or a shutter mode. A frame rate means the number of captured images in a unit time. A shutter mode means the time consumed for capturing images at each frame rate. For each clock frequency, the frame rate is inversely proportional to the shutter mode.

The conventional optical mouse adjusts both the frame rate and the shutter mode to improve the quality of the captured images, where the shutter mode is directly controlled by a microprocessor (not shown) in the optical sensing module 11 while the MCU 12 adjusts the frame rate. However, regardless of how the frame rate and the shutter mode are modified, the conventional optical mouse will still keep the intensity of the light source 10 fixed in detecting the movement of the mouse 1.

### SUMMARY OF THE DISCLOSURE

It is an object of the present invention to provide an optical input device that can effectively detect a movement of the input device on a working surface for improving the cursor control in a computer display.

It is another object of the present invention to provide an optical input device that modifies the intensity of its light source to improve cursor control.

In order to accomplish the objects of the present invention, the present invention provides an optical input device having a light source for emitting a light beam over a working surface that generates a reflected light beam. The input device further includes an optical sensing module that detects the reflected light beam from the working surface, and which stores a coefficient. The input device also has a control unit coupled to the optical sensing module for reading the coefficient and outputting a feedback signal based on the coefficient, and a current controller coupled to the control unit for receiving the feedback signal and, based thereon, modulating the light beam generated by the light source.

### BRIEF DESCRIPTION OF THE DRAWINGS

FIG. 1 is a general schematic block diagram of a conventional optical input device.

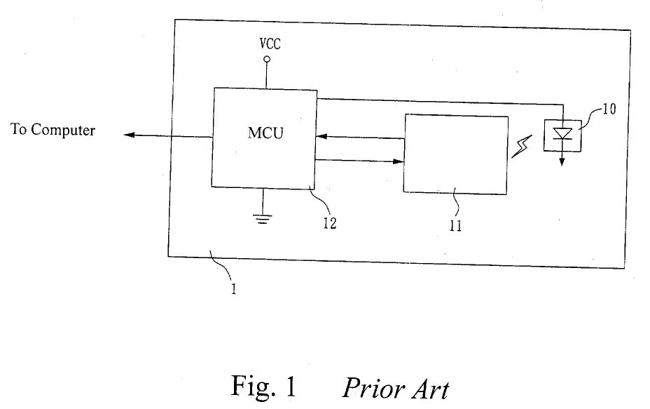

FIG. 2 is a general schematic block diagram of an optical input device according to the present invention.

FIG. 3 is a flowchart illustrating the operation of an optical input device according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides an optical input device that has an illumination-controlling device for modulating the intensity of the light source of an optical input device so as to improve the quality of the control of the cursor movement on a computer display.

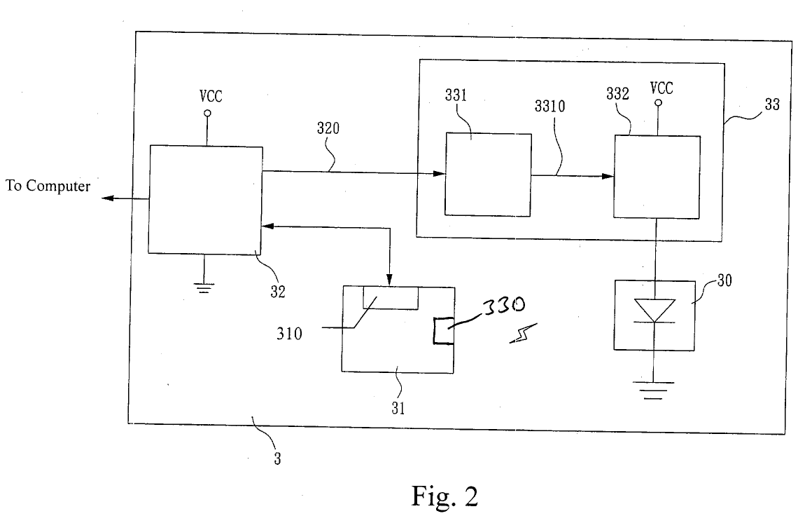

FIG. 2 is a simple schematic block diagram of an optical input device 3 (e.g., a mouse). The optical input device 3 has an optical sensing module 31 that has a register 310. The optical sensing module 31 retrieves a coefficient called “surface quality value” (SQUAL) for representing a specific refraction of a working surface that has been projected by a light source 30. The value of the SQUAL will vary depending on the characteristics of the working surface. Specifically, as the optical input device 3 is moved over a working surface, the refraction of the working surface is detected, and based thereon, an appropriate SQUAL value is stored in the register 310. The register 310 stores the most-recent SQUAL value.

The SQUAL is a value that is determined based on experimental data. For example, when the intensity of the illumination of a light source 30 is fixed, the SQUAL may be set to zero if the working surface is black (i.e., if there is no light reflection). Similarly, the SQUAL may be set to 256 if the working surface is a mirror-like surface (i.e., if there is full light reflection). The manufacturer of the optical sensing module 31 can define a range of preferred SQUAL values (e.g., ranging from 90 to 150) in which the optical input device 3 can obtain better refraction when capturing images. Thus, each variation of a different material and/or color of the working surface will have a different corresponding SQUAL value, so that the optical sensing module 31 will retrieve a corresponding SQUAL value that represents a different specific characteristic of the working surface.

The SQUAL values in the register 310 are read by an MCU 32 that is connected to the optical sensing module 31. The MCU 32 is coupled to a current controller 33. The MCU 32 utilizes the SQUAL value received from the optical sensing module 31 and calculates a feedback signal 320 that is transmitted to the current controller 33 to control the intensity of the illumination of the light source 30 based on the SQUAL coefficient. The current controller 33 includes a converter 331 (such as a digital to analog converter) that outputs a controlling current 3310 based on the feedback signal 320. The controlling current 3310 is provided to a constant current circuit 332. The constant current circuit 332 is coupled to the light source 30 such that the intensity of the light source 30 can be adjusted based on the SQUAL value. The constant current circuit 332 can be embodied in the form of known circuits such as the Model 3904 manufactured by Philips Semiconductor. The light source 30 can be embodied in the form of a conventional light emitting diode (LED) or the like.

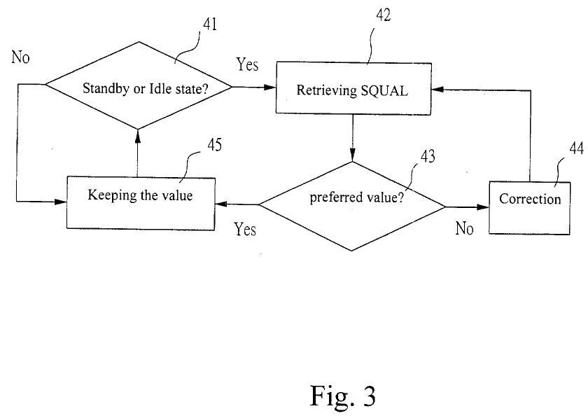

FIG. 3 is a flow chart illustrating the operation of the optical input device 3. When a user turns on a computer which is operatively connected to the optical input device 3, the optical sensing module 31 will detect a SQUAL value and stores it in the register 310. Even throughout the operation of the flowchart of FIG. 3 (i.e., at all times while the optical input device 3 is being moved), the optical sensing module 31 will continuously detect SQUAL values and store the most-recently detected SQUAL value in the register 310. In other words, the SQUAL value in the register 310 will “float” as the optical input device 3 is moved around a working surface.

In Step 41, it is determined if the input device 3 is in an idle mode. The input device 3 is in the idle mode when the input device 3 has not experienced any motion for a period of time. If yes, processing proceeds to step 42. If not, this means that the input device 3 is in a working mode, and processing then proceeds to step 45. In other words, in this illustrated embodiment, the present invention performs its adjustments only when the input device 3 is in the idle mode.

However, according to an alternative embodiment, it is also possible for the present invention to perform its adjustments only when the input device 3 is in the working mode. In such an embodiment, step 41 will be to determine if the input device 3 is in the working mode. If yes, processing proceeds to step 42. If not, then processing then proceeds to step 45.

There is yet another alternative embodiment, where the present invention performs its adjustments regardless of the mode that the input device 3 is in. In other words, the adjustments will be performed in both the idle and working modes. In such an embodiment, step 41 will be omitted, step 42 will be the starting point, and the output of step 45 returns to step 42.

In step 42, with the input device 3 being in the idle mode, the MCU 32 retrieves the SQUAL value that is currently in the register 310. It should be noted that the SQUAL value in register 310 will continuously change because the optical sensing module 31 will be continuously detecting SQUAL values, regardless of whether the input device 3 is in the working mode or the idle mode. Then, in Step 43, the MCU 32 determines if the just-retrieved SQUAL is a preferred value. In other words, the MCU determines if the SQUAL value is within the range of preferred values. For example, using the preferred range of 90 to 150 described above, if the SQUAL value is between 90 and 150, then the SQUAL value is determined to be a preferred value. If the SQUAL value is a preferred value, then processing proceeds to step 45, where the SQUAL value is maintained during the operation of the input device 3.

On the other hand, if the just-retrieved SQUAL value is outside the range of preferred values (e.g., less than 90 or greater than 150), then processing proceeds to step 44, where a correction (also referred to herein as “adjustment” ) will be performed. During this step 44, one of the following adjustments will occur, depending on what the just-retrieved SQUAL value is: (i) the present frame rate will be adjusted, or (ii) the shutter mode will be adjusted, or (iii) the MCU 32 will send the feedback signal 320 to the current controller 33 that will adjust the intensity of the light source 30. The intensity of the light source 30 is adjusted by the current controller 33 based on the controlling current 3310. The MCU 32 performs the function of adjusting the frame rate, while a microprocessor 330 in the optical sensing module 31 operates using techniques known in the art to control the shutter mode. In step 44, any of the three adjustments (i), (ii) and (iii) will modify the successive SQUAL values that are detected by the optical sensing module 31. For example, increasing the number of the captured images in a unit time will change the frame rate, while increasing the time consumed for capturing images during each frame rate will change the shutter mode. In this regard, for each clock frequency, the frame rate is inversely proportional to the shutter mode.

After step 44 is performed, processing will proceed to step 42 again, and the MCU 32 will determine again (in step 43) if the next retrieved SQUAL value is now within the range of preferred values. If the next retrieved SQUAL value is now within the range of preferred values, processing then proceeds to step 45, where this newly-retrieved SQUAL value would be maintained. If the next retrieved SQUAL value is still outside the range of preferred values, processing is returned to step 44 which will continue to correct the frame rate, the shutter mode and/or the intensity of the light source 30. For example, if the newly-retrieved SQUAL value (e.g., 40) is still outside the range of preferred values (e.g., 90-150), then the MCU 32 will perform step 44 again, after which another new SQUAL value is generated (e.g., 100), which in this example falls within the preferred range (i.e., 90-150). Since this new SQUAL value (e.g., 100) is now within the preferred range, further corrections (i.e., step 44) are no longer needed.

Thus, the present invention provides the optical input device 3 has a current controller 33 that adjusts a preferred illumination of a light source 30 such that a preferred image captured by the optical sensing module 31 can be obtained therefrom. By modifying either the frame rate, shutter mode or intensity of the illumination, one creates a new environment that will improve the quality of the captured image.

The light source 30 can be operated in a power-saving or sleep mode. Once the operation of the optical input device 3 begins, the light source 30 will return to a full-lighting state. Still, this power-saving mode is not involved in the various illuminations in detecting the movement on the working surface depicted in the present invention.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An optical input device, comprising:
a light source for emitting a light beam over a working surface that generates a reflected light beam;
an optical sensing module that detects the reflected light beam from the working surface, and which stores a coefficient relating to the refraction of the reflected light beam;
a control unit coupled to the optical sensing module for reading the coefficient and outputting a feedback signal based on the coefficient; and
a current controller coupled to the control unit for receiving the feedback signal and, based thereon, modulating the light beam generated by the light source.

2. The device of claim 1, wherein the coefficient is stored in a register within the optical sensing module.

3. The device of claim 1, wherein the coefficient is a surface quality value (SQUAL).

4. The device of claim 1, wherein the light source is a light emitting diode.

5. The device of claim 1, wherein the control unit modulates a frame rate and/or a shutter mode based on the coefficient.

6. The device of claim 1, wherein the modulating means further comprises a converter that receives the feedback signal and outputs a controlling current.

7. The device of claim 6, wherein the modulating means further comprises means for controlling the current to the light source for fixing the intensity of the illumination.

8. The device of claim 7, wherein the converter is a digital to analog converter.

9. The device of claim 1, wherein the input device is an optical mouse.

10. A method of controlling the intensity of a light source in an optical input device that is moved over a working surface, comprising:
a. retrieving a coefficient that represents a refraction of the working surface that has been projected by the light source;
b. determining whether the coefficient is a preferred value; and
c. correcting either the present frame rate or the shutter mode, or modifying the intensity of the light emitted from the light source, if the coefficient is not a preferred value.

11. The method of claim 10, wherein the preferred value is a value that falls within a predetermined range of values.

12. The method of claim 10, wherein step (a) is performed when the optical input device is in an idle state.

13. The method of claim 10, further including:
d. keeping the coefficient unchanged if the coefficient is a preferred value.
